(19) United States
(12) Patent Application Publication
(10) Pub. No.: US 2018/0104849 A1
(43) Pub. Date: Apr. 19, 2018

(54) CUT AND MOVEMENT FABRICATION SYSTEM

(71) Applicant: DENNIS RAY DICKSON, ALEXANDRIA, LA (US)

(72) Inventor: DENNIS RAY DICKSON, ALEXANDRIA, LA (US)

(21) Appl. No.: 15/782,244

(22) Filed: Oct. 12, 2017

Related U.S. Application Data
(60) Provisional application No. 62/408,915, filed on Oct. 17, 2016.

(51) Int. Cl. B28D 1/00; B28D 1/04; B28D 1/10; B28D 1/12; B28D 7/04; B28D 7/00; B28D 7/02

(52) U.S. Cl. CPC B28D 1/003; B28D 1/043; B28D 1/10; B28D 7/02; B28D 7/04; B28D 7/005; B28D 1/121

(57) ABSTRACT

Stone fabrication machine and movement system for granite and quartz. The industry has always faced three challenges. 1) Moving a material that is extremely heavy; possibly weighing up to 1200 lbs. 2) not damaging material when moving, processing and installing. 3) Safety. It is the Cut and Polish Complete Fabrication System that installed, with utilities, water, electric, and air are also installed, you can fabricate from start to finish. You provide a forklift and utilities and our fabrication system will do the rest. This is new way to fabricate in two ways using only one person: only moving the piece twice-once to lay on the tables and second loading for delivery. Currently pieces are moved 3 to 6 times averaging 4, meaning taking 2 to 3 fabricators. Utilities distributed throughout machine for cutting and a separate utility bar for operator. This machine becomes the hub of entire shop.

### BACKGROUND

The fabrication of material including but not limited to granite, marble, quartz, and limestone has been around over hundreds of years. The material is fabricated for residential kitchen, baths and commercial places like hotels, bars, and airports. There are three challenges in this industry. 1) Moving materials that are very heavy. A slab of granite can weigh 1,000 to 1,200 pounds. 2) The risk of damaging material by moving, processing and installing. 3) Lastly is the safety issue. Besides the weight issue, there is electrical, power tools, water and dust when cutting and polishing. The industry has made equipment mostly limited to one function. One to cut, one to profile, one for sinks, etc., which has created an industry of 2 types of fabrication. All digital which cost approximately $300,000.00 to $1,000,000.00 or the processing manually using hand tools which cost approximately $3,000 to $10,000. Because the cost difference is so huge the vast majority are fabricated manually. So we created this machine to create a new option in the $30,000-$60,000 range.

### BRIEF SUMMARY OF THE INVENTION

We have created a machine that is truly innovative. It is called Cut and Polish Fabrication System. One machine, many functions. Once this machine is installed, and utilities, water, electric, and air are installed, you will be able to fabricate from start to finish. You provide a forklift and utilities and our fabrication system will do the rest. This is more than a machine; it is truly a new way to fabricate materials. Comprised of two sections; first the machine with all its attachments and secondly a complete measurement and movement system consisting of tables and ball transfer bearings. Once the slab is laid down it is ready to be moved to stops and cut straight edge. Then push to premeasured point with pin stop of measurement desired. Make cuts. You have made two cuts completing the cutting to needed width. The piece is now ready to be moved to a holding roller tables. It will remain there until all pieces are cut to width. This process continues until all pieces are cut to width. When completed cutting the widths the pieces can be rolled around to cut to length. With calibrated preset holes drilled one inch apart and the set of calibrated pins are in place you can cut to length. The cut will be accurate within ⅛″ without the use of a tape measure. Now that all pieces have been sawed, profiled and polished you can finish the fabricating using hand tools. Now being on roller tables, pieces are profiled if needed, then cut and polishes any inside and outside corners as needed. If a sink is needed to be cut out it has be rodded first. Rodded sinks are now ready to be cut out safely. Once rodded it is polish and ready to be sealed with all the pieces for that job. After all pieces are sealed they is ready to load on delivery vehicle. This is remarkable in two ways: first, you only move the piece twice; once to lay on the tables and the second is when it is loaded to delivery vehicle. Currently all pieces are moved 3 to 6 times with an average of about 4 times. Also, during the move, it takes 2 to 3 people to move it, disrupting other workers from what they were working on. So as a result, it is done in ½ the time with ½ the man power. Also this system has a very small footprint which is great for small operators with limited space. FIG. 1-5 are views of machine. FIG. 6 is a cutting extension. FIG. 7 is a utility distribution system. FIG. 8-10 are control panels to PLC. FIG. 11-16 is the base and top table with roller bearings. FIG. 17-20 are measurement and stop for precise cuts. FIG. 21-17 show process of cutting and set up to profile and polish. The extension tables and how used to process material.

### BRIEF DESCRIPTION OF DRAWINGS

FIG. 1. FULL VIEW FRONT LEFT

FIG. 2. RIGHT VIEW

FIG. 3. TOP VIEW TABLE AND MACHINE

FIG. 4. MOTOR-FORWARD AND REVERSE CUT

FIG. 5. MOTOR ASSEMBLY

FIG. 6. SLIDE EXTENSION

FIG. 7. UTILITIES DISTRIBUTION

FIG. 8. CONTROLLERS

FIG. 9. MANUEL CONTROLLER

FIG. 10. REMOTE CONTROLLER

FIG. 11. TABLE OVERLAYS

FIG. 12. BASE TABLE

FIG. 13. PHASE 1 TOP TABLE 2 SIDES

FIG. 14. PHASE 2 TOP TABLE BEARINGS AND STOPS

FIG. 15. PHASE 3 TOP TABLE BOARD OVERLAY

FIG. 16. PHASE 4 TOP TABLE COMPLETED TABLE TOP

FIG. 17. MEASURING BARS

FIG. 18. MEASURING PIN

FIG. 19. MEASURING SYSTEM

FIG. 20. BALL TRANSFER BEARINGS

FIG. 21. MACHINE WITH SLAB ON TABLE

FIG. 22. MACHINE WITH SLAB CUT ON TABLE

FIG. 23. MACHINE WITH HOLDING TABLES

FIG. 24. TABLE CUTTING SLAB IN PIECES

FIG. 25. MACHINE CUTTING SLAB CUT AND MOVED TO HOLDING TABLE

FIG. 26. ROTATE PIECES TO CUT

FIG. 27. CUT PIECES READY TO PROFILE AND POLISH

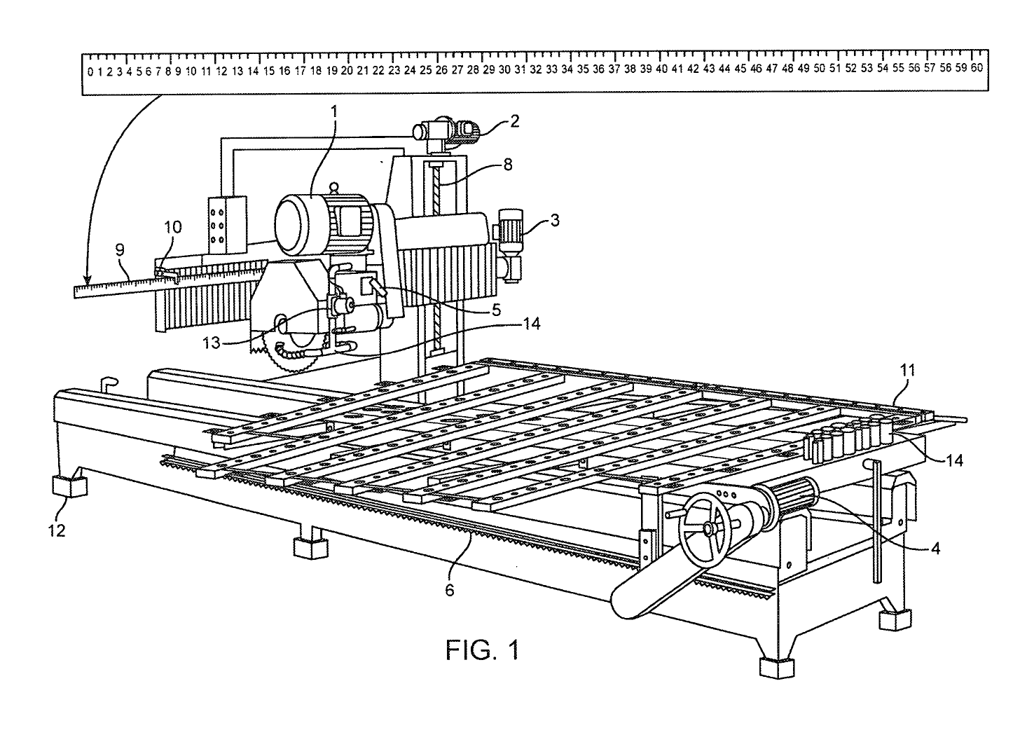

FIG. 1: Full View Front Left
1. Main cutting motor
2. Up/Down motor
3. Left/Right motor
4. Forward/Reverse motor
5. Laser
6. Steel rail track with teeth for gears to run
7. End of machine table stop
8. Shaft for up/down with linear guide
9. Ruler
10. Pointer in ruler
11. Table
12. Blocks to raise

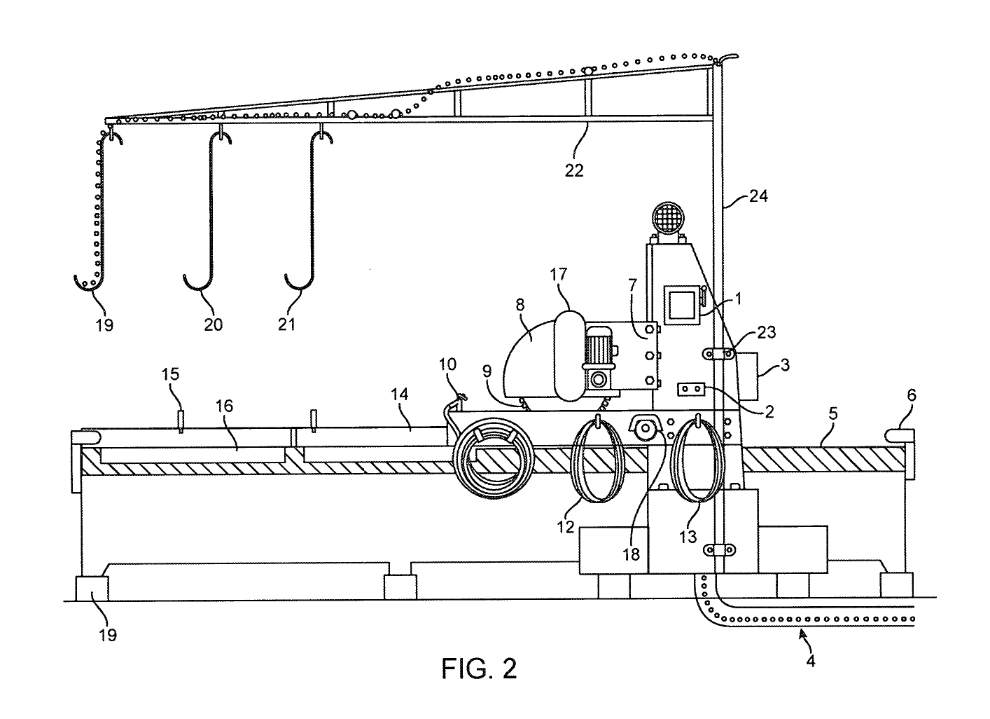

FIG. 2: Right View
1. AC power cut off
2. AC 110 volt outlet
3. Power box with PLC and remote control
4. Utilities running underground
5. Top cover of tracks
6. End of table stops
7. Adjust to track movement system up/down
8. Saw blade guard
9. Saw blade
10. Water spigot
11. Water hose
12. Air hose
13. Electric cord
14. Table for slabs
15. Pins for measuring or stops
16. Counter weights for tables
17. Cover guard for motor and pulleys
18. Hand saw
19. Blocks raising machine height

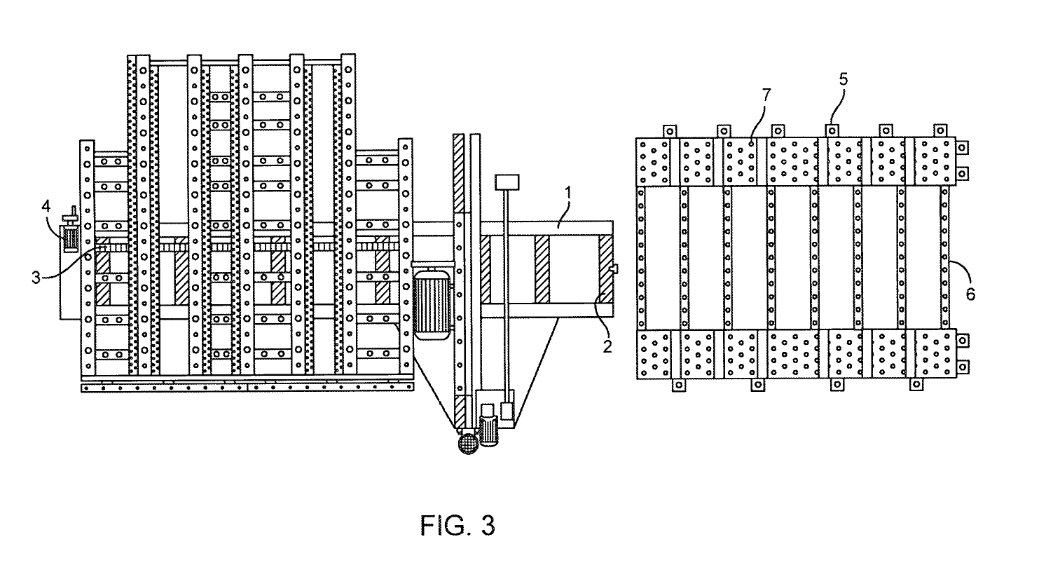

FIG. 3: Top View Table and Machine
1. Top view of machine oil-immersed rollers
2. Cross support of frame
3. Cable that rolls with power cable inside
4. Motor cover forward/reverse
5. Pin stops holders
6. Bridge bars
7. Ball transfer tables

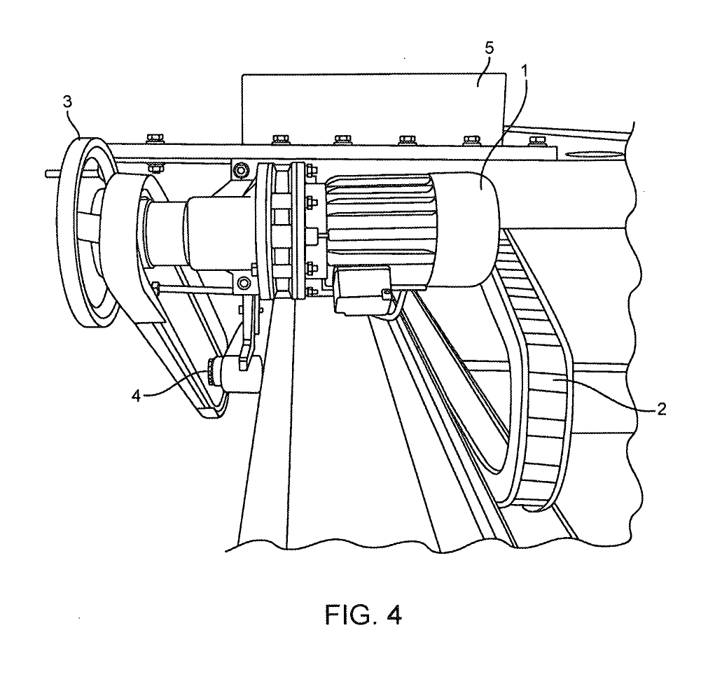

FIG. 4: Motor
1. Motor for forward and reverse cutting
2. Track wire AC power rolling
3. Handle
4. Gear connecting upper table to lower
5. Motor box cover

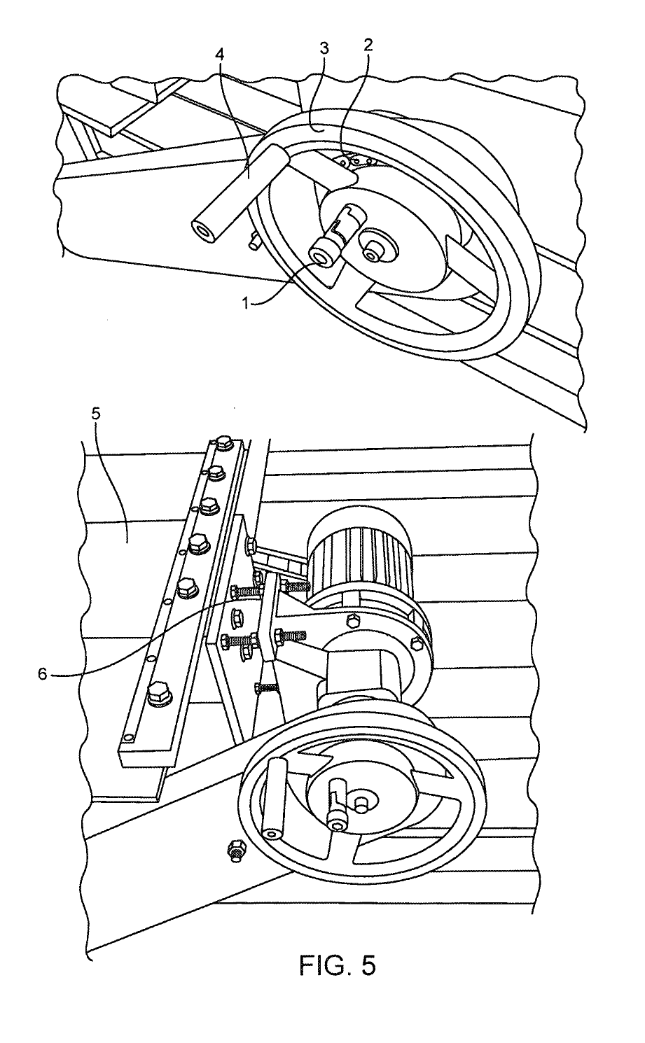

FIG. 5: Motor Assembly
1. Motor disable switch
2. Chain connect upper and lower gear
3. Roller wheel
4. Roller grip on wheel
5. Base table
6. Mounting assembly

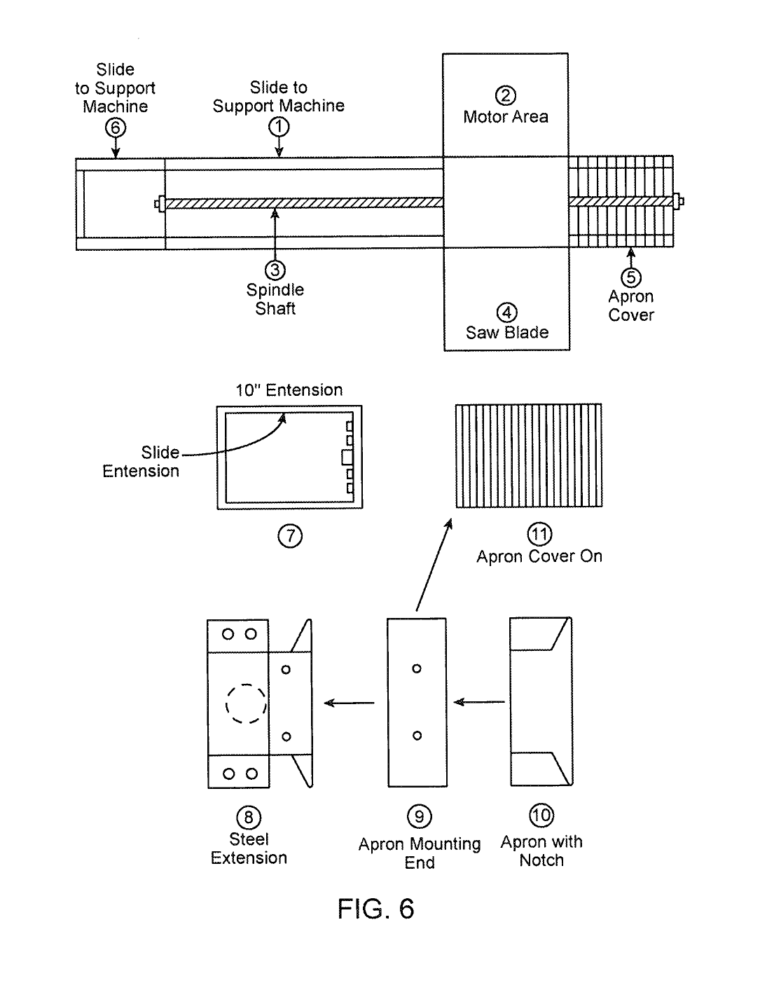

FIG. 6: Slide Extension
1. Slide to support machine
2. Motor area
3. Spindle shaft
4. Saw blade
5. Apron cover
6. Slide extension for apron cover
7. 10″ slide extension
8. Steel extension
9. Apron mounting end
10. Apron with notch
11. Apron cover on

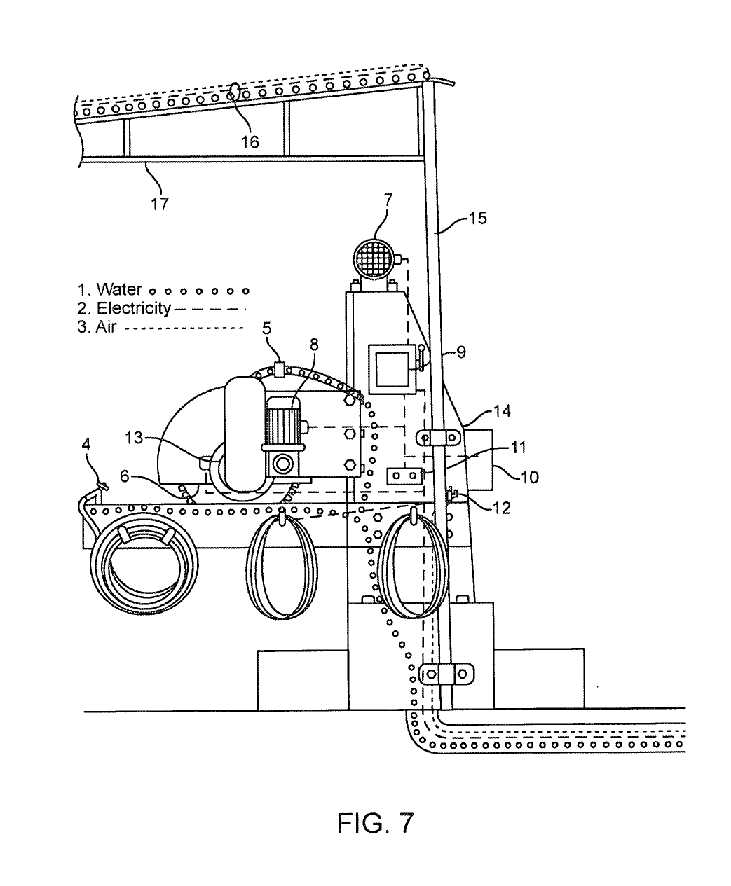

FIG. 7: Utilities Distribution
1. Water
2. Electricity
3. Air-compressed
4. Water spigot
5. Solenoid controlled water valve
6. Water to cool blade
7. AC to up/down motor
8. AC to left/right motor
9. AC disconnect
10. Power control box
11. AC 110 outlet
12. Air valve and hook up air hose
13. AC to main motor

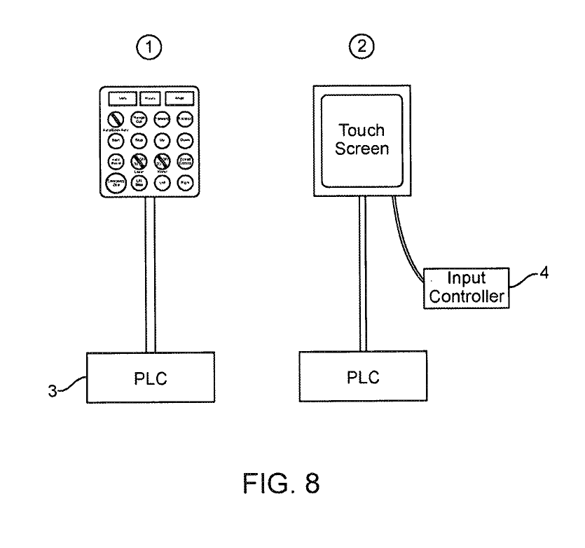

FIG. 8: Controllers
1. Manual control panel
2. Touchscreen control panel
3. Programmable logic controller
4. Input controller

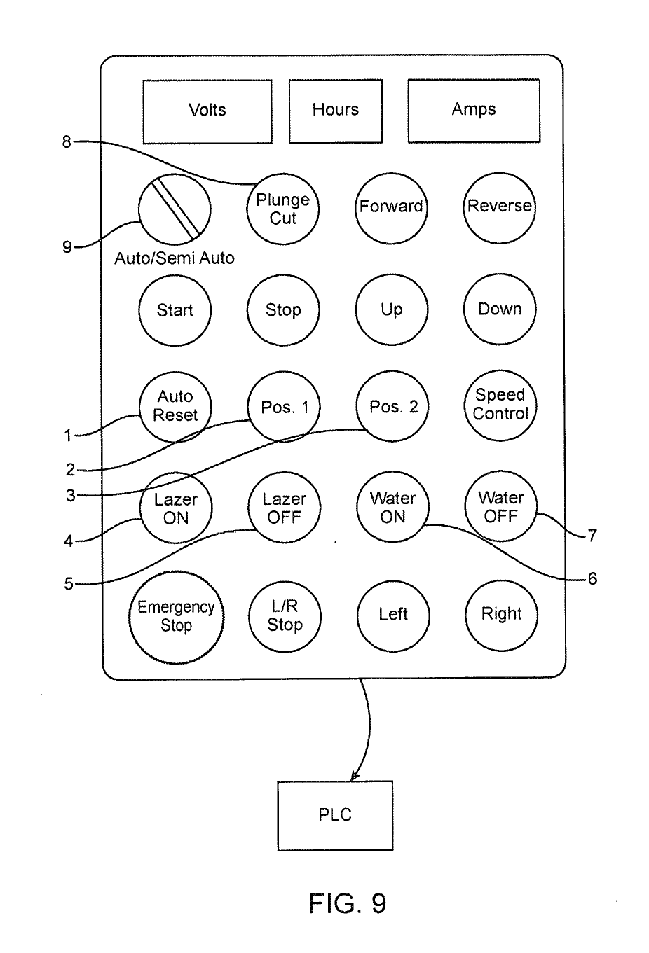

FIG. 9: Manual Controller
1. Auto reset
2. Position 1
3. Position 2
4. Laser on
5. Laser off
6. Water on
7. Water off
8. Plunge cut
9. Auto cut

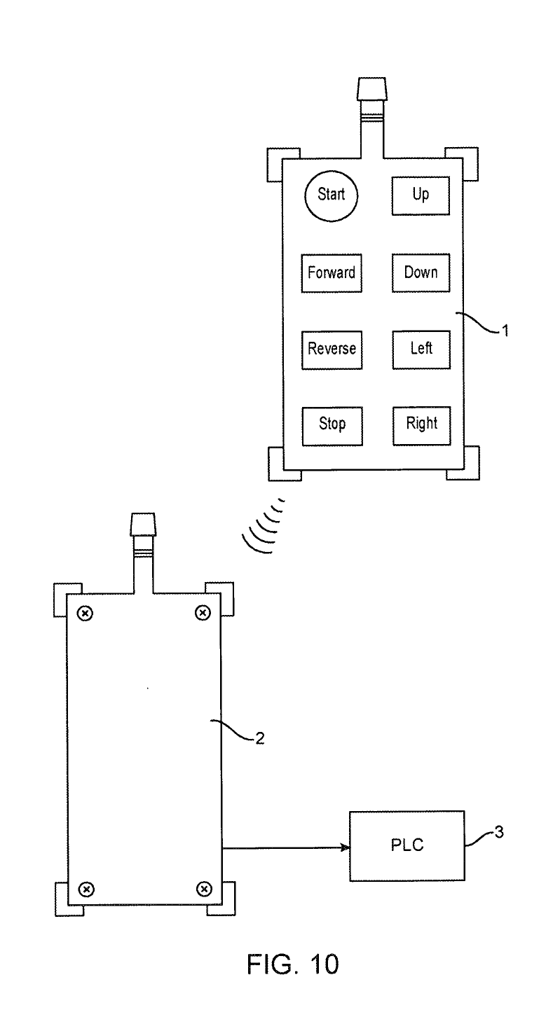

FIG. 10. Remote Controller
1. Wireless remote
2. Wired controller
3. Programmable logic controller

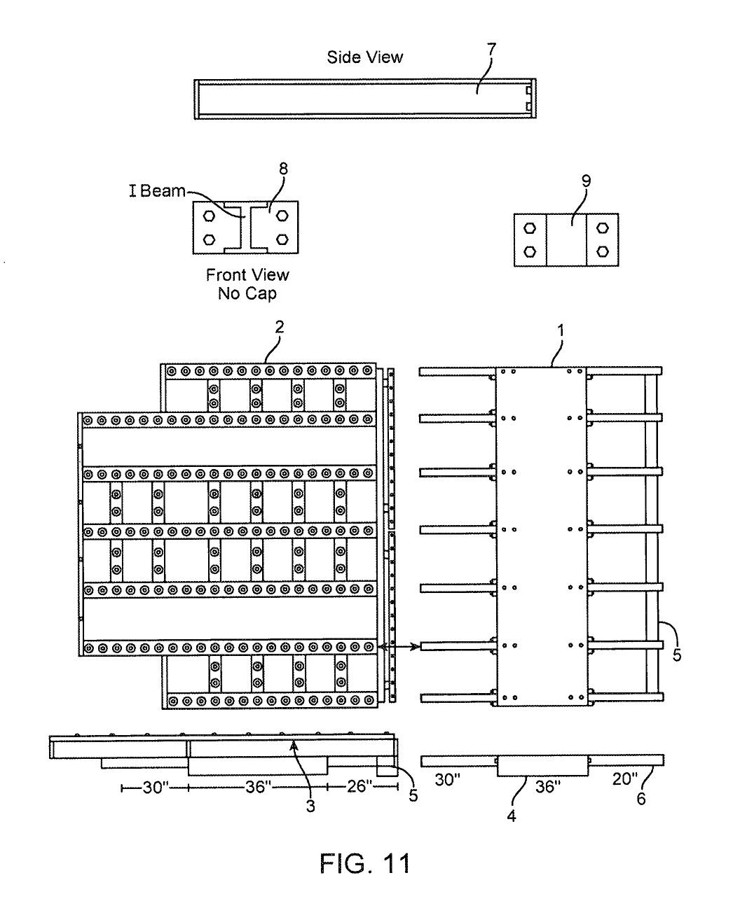

FIG. 11: Table Overlays
1. Base table with supports
2. Top table
3. Boards with exposed bearings
4. Side view of base table
5. Counter weight on top table

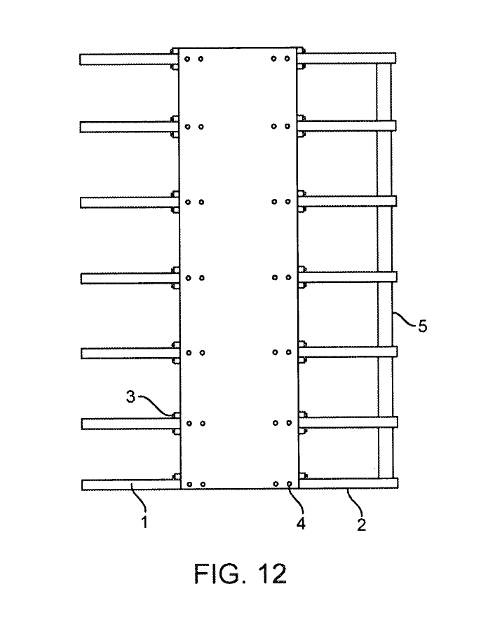

FIG. 12: Base Table
1. 26″ support
2. 20″ support
3. Tapped and bolted supports
4. Drilled and tapped to bolt top overlay table

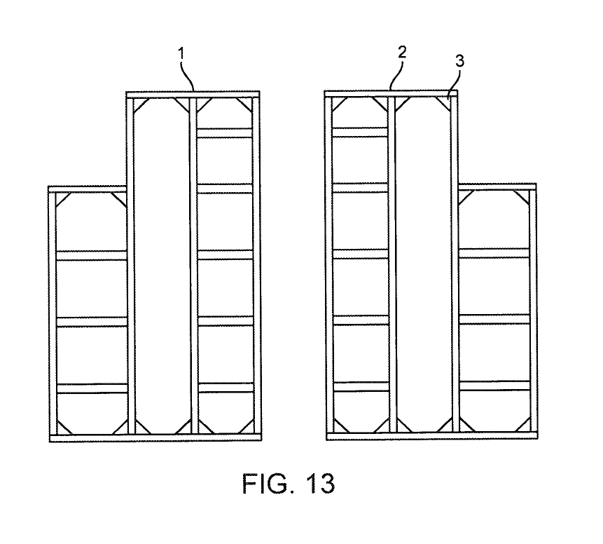

FIG. 13: Phase 1 Top Table 2 Sides
1. Left side welded together
2. Right side welded together
3. Angle braces welded for support

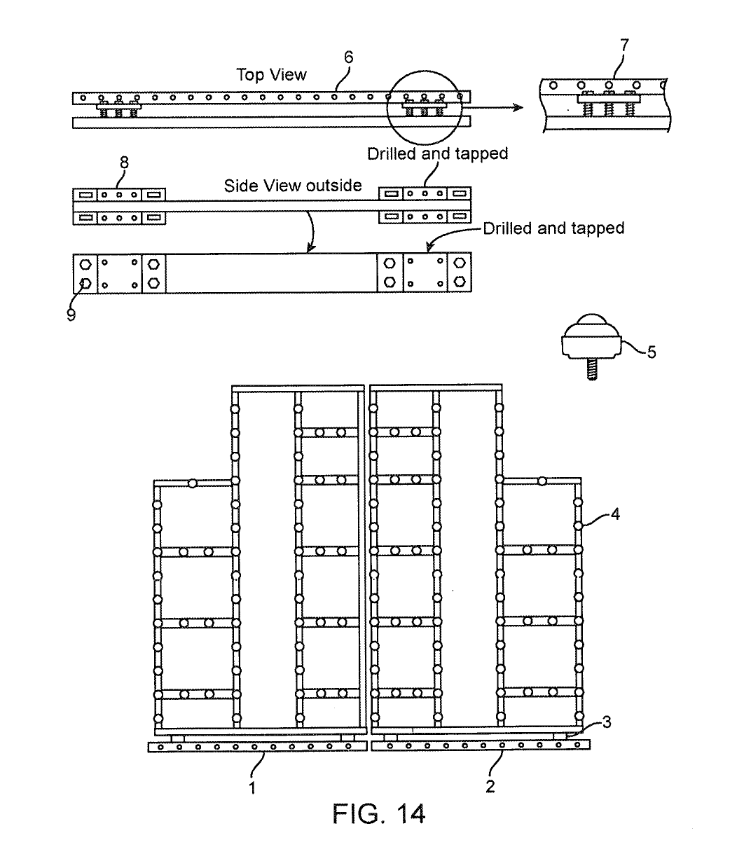

FIG. 14: Phase 2 Top Table Bearings and Stops
1. Left side stop and squaring module attached
2. Right side stop and squaring module attached
3. Adjustable plates to attach and square tables
4. Ball transfer bearing added
5. Side view of ball transfer bearing
6. Top view of adjustable plate
7. Close up view of adjustment system
8. Side view
9. Plate on top table

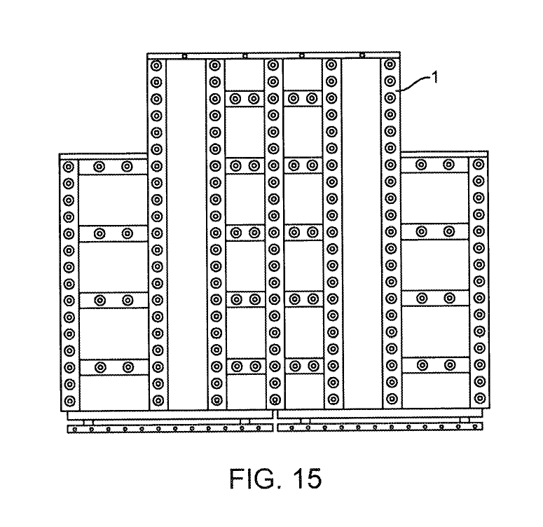

FIG. 15: Phase 3 Board Overlay
1. Board overlay

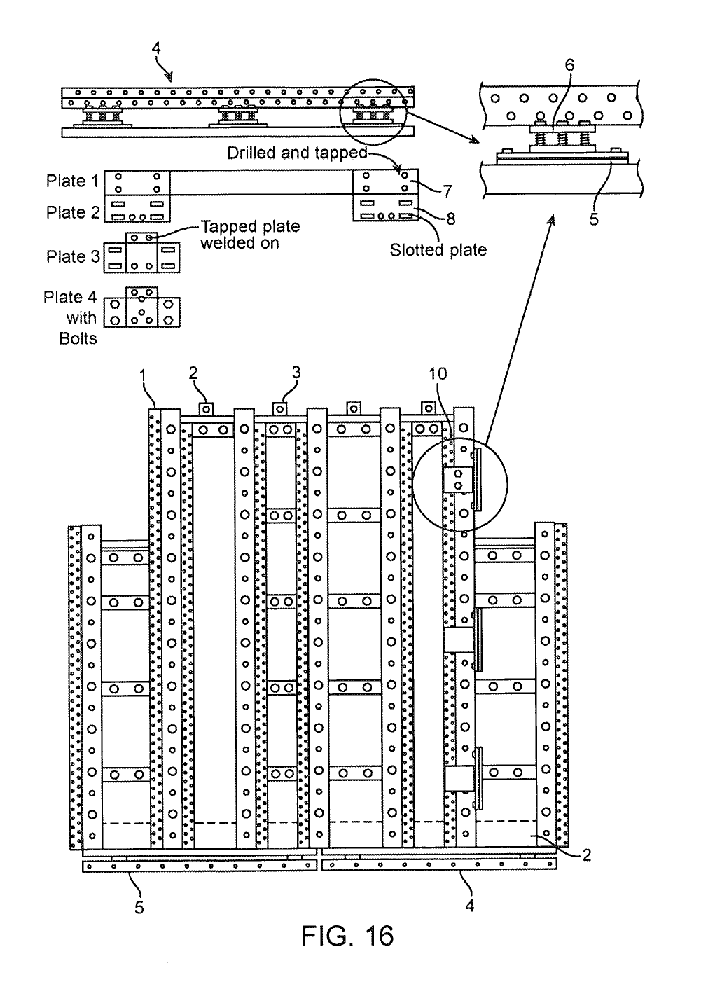

FIG. 16: Phase 4 Completed
1. Measuring bars gauged in 1″ increments
2. Stop pin holder
3. Counter weights
4. Aligning squaring and stops

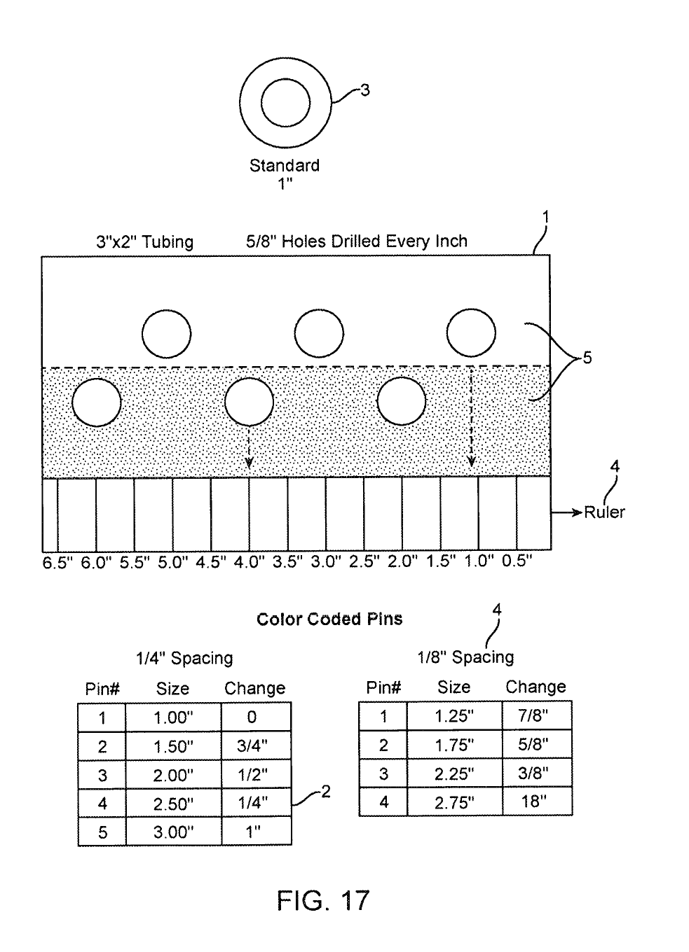

FIG. 17: Measuring Bars
1. Layout and Measuring
2. Size Pin # Reference
3. Standard base pin 1¼″

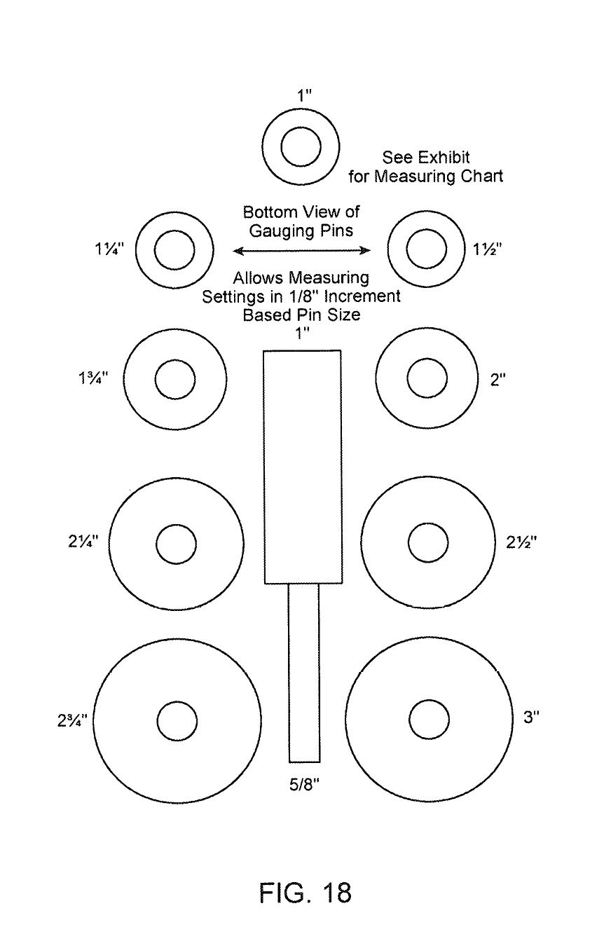

FIG. 18: Measuring Pin
1. Sizing pins for chart on FIG. 17

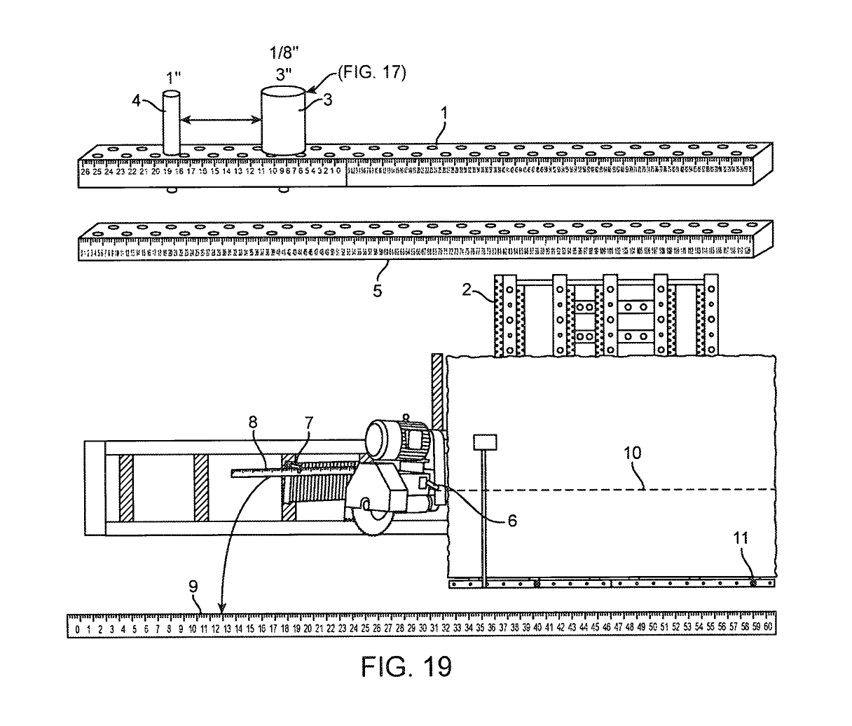

FIG. 19: Measuring System
1. Measuring bar for 26″ to 96″
2. Top view
3. 3″ in pin
4. 1¼″ pin
5. Measure bar 0-120″
6. Laser
7. Pointer to show measurement
8. Machine measuring ruler 0-60″
9. Close up of #8
10. Laser line on slab
11. Stop pin in place

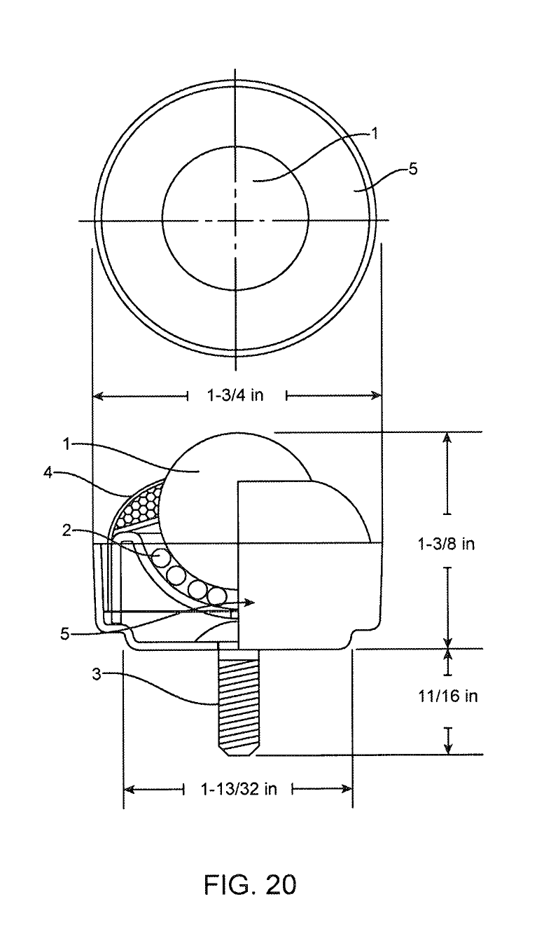

FIG. 20: Ball Transfer Bearings
1. 1″ ball bearing
2. 80⅛″ support bearings
3. Mounting stud
4. Membrane to block trash from getting to bearings
5. Outer cover

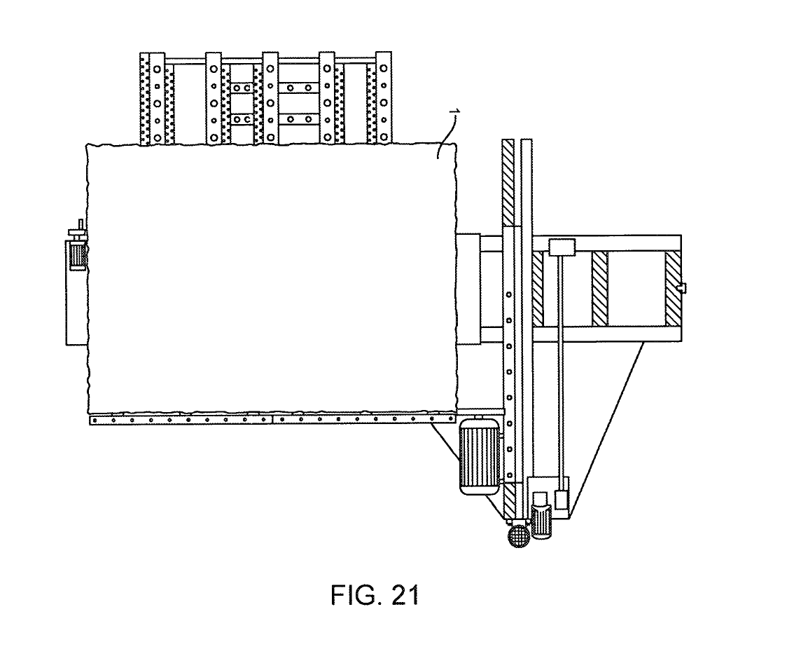

FIG. 21: Machine with Table
1. Full slab on table

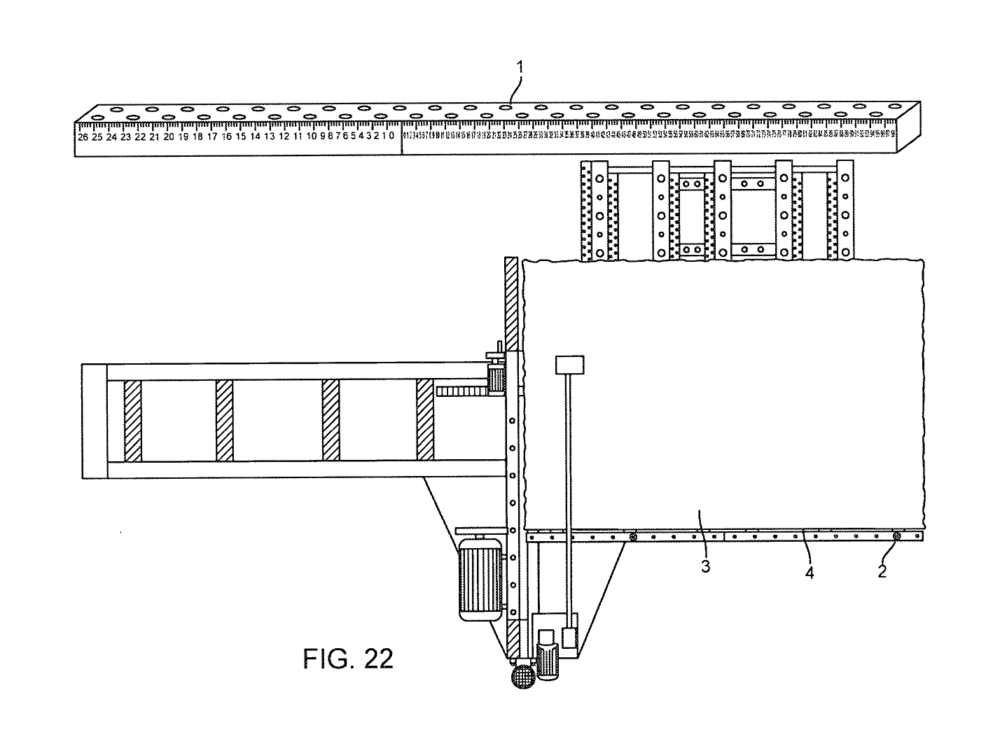

FIG. 22: Machine with Slab Cut on Table
1. Measuring and gauging
2. Stops in place
3. Slab
4. Slab with 1 side cut straight

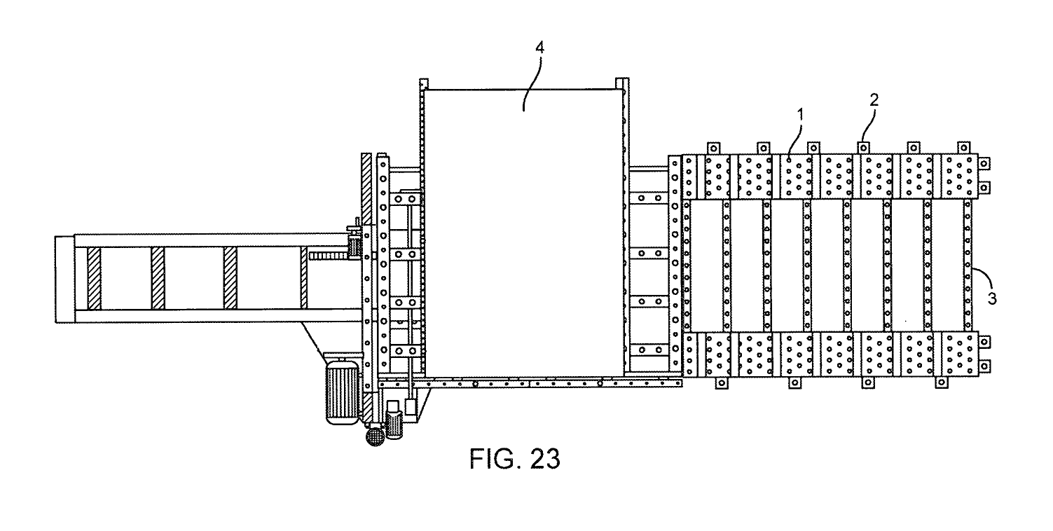

FIG. 23: Machine with Holding Tables
1. Roller tables
2. Pin stop holders
3. Bridge bar supports
4. Slab with side and all four sides now square

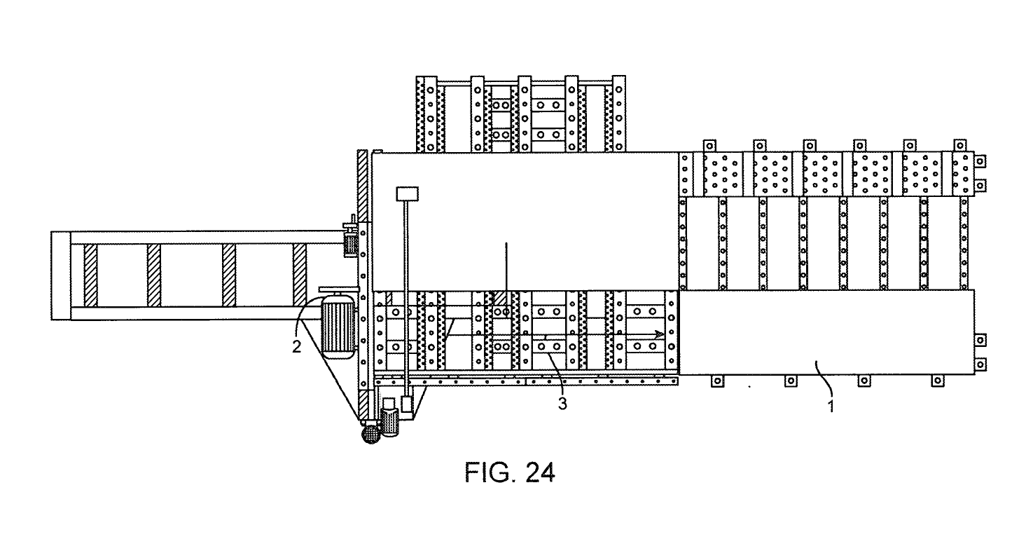

FIG. 24: Table Cutting Slab
1. Saw head moved to 26″
2. 1^{st} cut on slab
3. 26″ piece cut and moved to holding table

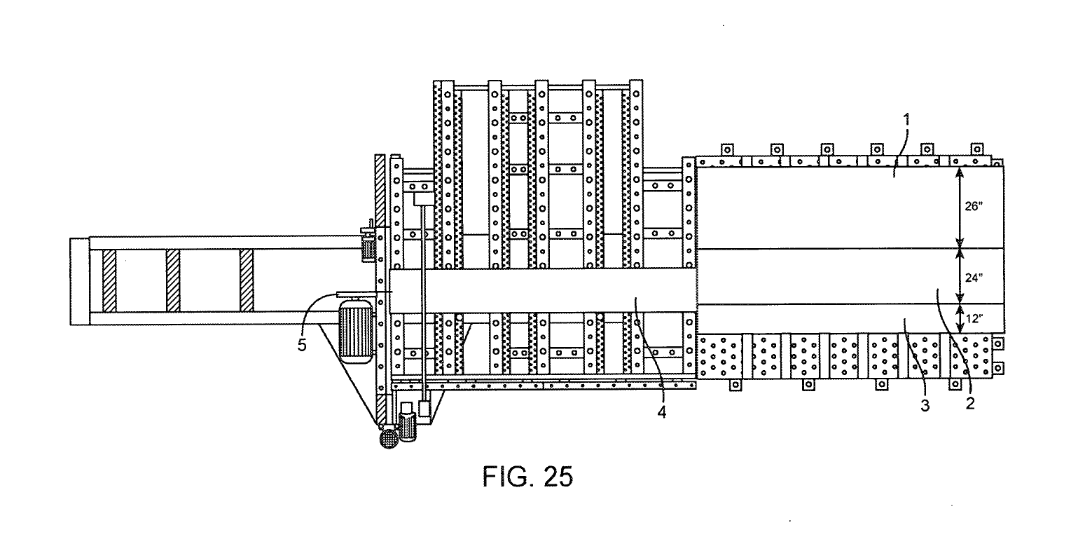

FIG. 25: Machine Cutting Slab
1. 1^{st} cut 26″ move up
2. 2nd move over and up
3. 3^{rd} cut 12″ move over and up
4. Set for 4^{th} and 5^{th} cuts each 5″
5. Motor head still in fixed position at 26″

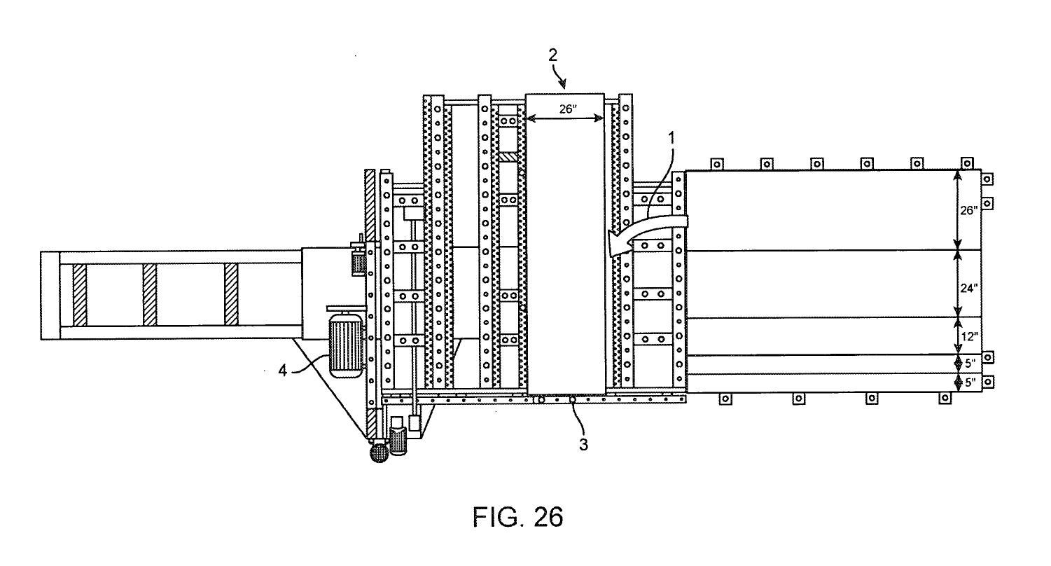

FIG. 26: Rotate Pieces to Cut

1. 26″ pieced is moved in position to crosscut to correct length
2. Piece set to cut to length
3. Put stop pins at desired length
4. Move motor if needed to make cuts

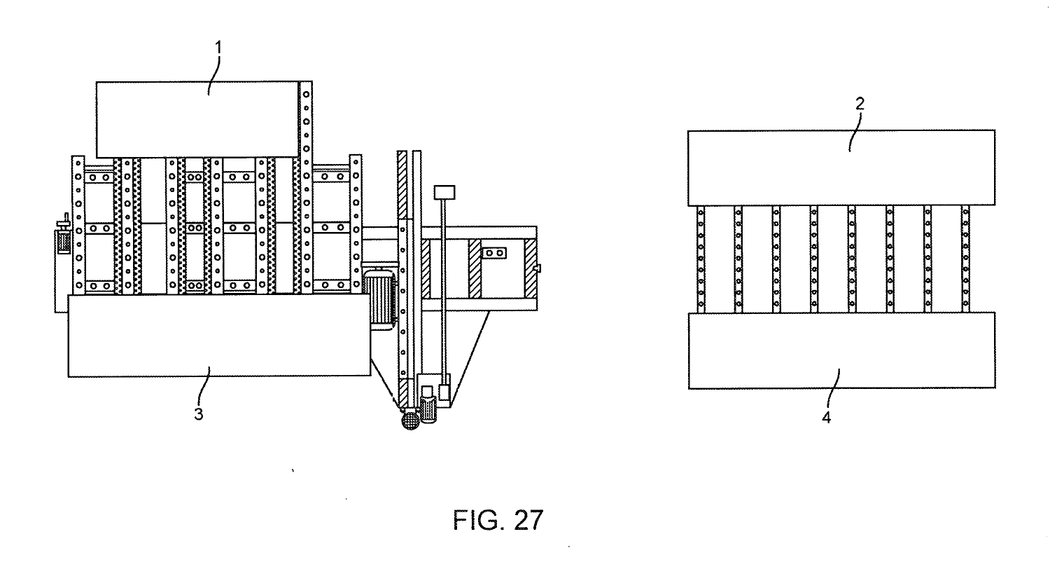

FIG. 27: Cut Pieces Ready to Profile and Polish
1. Piece 1
2. Piece 2
3. Piece 3
4. Piece 4

FIG. 1: Full View Front Left
1. Main cutting motor is a 20 HP motor on a cantilever arm over the cutting table.
2. The second motor on the side is used for raising and lowering the spindle attached with a linear guide system. This is also used for auto reset and plunge cutting.
3. The third motor on side allows head to move from left to right. A ruler attached allows you to read and set measurements from 0-60″
4. Forward/Reverse motor is the motor actually used to move cutting table forward and back for all cutting. It is available in single speed or variable speeds.
5. Laser is the measurement tool used for cutting. You can mark your ends start and finish or drawn out complete section or have laser points to lines drawn on or piece or the tape measure mounted on table to align the required cut.
6. Steel rail track with teeth for gears to run—The machine has two distinct separate parts. The fixed frame sitting on the floor and a table sitting on the base to roll forward and reverse for cutting. So to move the table a gear assembly on upper and a lower gears are connected by a chain. The gears attached to the rail allowing table to move forward and reverse.
7. End of machine table stop—These are flexible stops to assist machine in coming to a complete stop smoothly at end of cut. There is one at each end of machine.
8. Shaft for up/down uses a linear guide system. Both the movement up and down and left to right have these linear guide systems. This is a special designed with a shaft sliding on collar assemblies that uses stainless steel ball bearings for movement. They reduce friction by up to 80%. So you have shaft rolling on ball bearings compared to metal on metal.
9. Ruler-We have a 60″ ruler mounted on steel bar that is mounted to machine assembly moving from left to right.
10. Pointer to ruler-Pointer is a fixed steel bar mounted to nonmoving part of cantilever with main motor. It points to measurement 0-60″ depending where motor stops
11. Table—is where the magic happens: cutting, sliding and placement of material effortlessly up to 360°. Stops using stop pins, gauging pins, and squaring pins that are fully described in FIG. 11-16.
12. Blocks are used to raise machine—to the needed height to working height so after cutting they can be profiled, polished and sealed.

FIG. 2: Right View
1. AC power cut off—complete machine. All power in machine runs through this box. So this is the distribution area where all AC comes from including motors and laser.
2. AC 110 volt outlet—the AC box with 2 plugs. They both are GFI protected.
3. Power box with AC PLC and with wireless remote control. The commands form the manual control, touchscreen control and auxiliary input got to the PLC. The PLC then sends commands to motors, lasers, water solenoid, and relays to complete desired function.
4. Utilities running underground-all utilities including electric, water and air come into machine through pipe in concrete into center. Then we distribute to needed areas.
5. Top cover of tracks—The track area is where the steel wheel roll on steel rail like a railroad track. This system is very durable. The track and rollers are in an oil bath for lubrication. Then covered to protect rollers from water and dust.
6. End of machine table stop—These are flexible stops to assist machine in coming to a complete stop smoothly at end of cut. There is one at each end of machine.
7. Adjustments to track movement system up/down—This machine slides rails with shims, locking nuts and adjust them for pressure on sliding assembly.
8. Saw blade guard—to keep water from being thrown all over shop area.
9. Saw blade-diamond saw blade. The blade is used to cut slab.
10. Water spigot—allows operator access to water without have hoses laying on the ground away from operation.
11. Water hose—the water hose is connected to #10 water spigot. This givers operator water to wash slabs, use for profile and polish and lastly keeping floor clean and safe.
12. Air hose connects to air valve which allows you to have air to operate vacuum hoist, blow slabs off to accelerate drying and run the air tools when polishing.
13. Electric cord-connects of AC plug used for hand saw and run power tools in profile and polishing process.
14. Table for slabs—is the table which really consist of two tables. The base table and the overlying top table bolted to the base.
15. Pins for measuring or stops-Pins that go in premeasured slots for measuring and stops please see explanation in FIG. 8-10.
16. Counter weights for tables. By design you are limited how far you can move slab to right of table which is 26″ but you need to put 120″ piece on the table. So if the table is 36″ and your rights sided is 26″ leaving 58″ overhang to left. So on right you have 26″ but on right you have 58″. Most of the time this is not a problem but when you move a 400-500 lb piece of material to that side of the table it will tilt over. So to correct this problem finding center of table and added weight which was level when 400 lbs are on the left. We then welded weight 100-300 lbs on right to achieve this. Once we found correct weight, we welded to underside of the table.
17. Cover guard for motor and pulleys—Cover is to protect from the elements.
18. Electric hand saw—is used in cases when it is easier to make quick cuts with small hand saw instead of repositioning a large piece of material multiple times.
19. Blocks raising machine height—to level the work tables so they can double as a cutting platform as well as profile, polish and seal.

FIG. 3: Top View Table and Machine
1. Top view of machine oil-immersed rollers—the trays on both sides of saw are rail (like railroad) tracks that steel wheels roll on. Then we fill tract with oil. So you have a railroad track filled with oil and covered to protect from water and dirt. So movement section of machine will work just as well in 10 years as the day the machine was put in service.
2. Cross support of frame-Welded steel beam connect left and right side completing the base of rolling section.
3. Track that rolls with power cable inside allows electric wire to roll motor forward and backward. It is protected in a chain like housing that rolls front to back protecting the wire from being broken or kinked during movement.
4. Forward[reverse movement motor cover is a protective metal cover over #1 to keep water, dirt, and dust out.
5. Pin stops holders—are steel blocks made out of tubing welded to table. In this machine we use 2″×2″×¼″ walls. They have ⅝″ hole drilled in them to match pins in FIG. 18.
6. Bridge bars—are steel tubing drilled for mounting ball transfer bearing. We drill ¼″ top and ⅝″ on bottom so we install bearing in ¼″ hole and use the ⅝″ bottom hole to install the nuts holding bearings in place. So it is 2″×2″×¼″ tubing with bearings mounted 4″ to 6″ apart. Then cut to length to fit between the 2 tables. Then insert on bracket on side of table and you bridged 2 tables together to roll material.
7. Ball transfer tables are steel tables with solid plate on top. The tables used in this system are 24″ by 120″. We have 80 holes drilled ¼ inch for ball transfer bearings. We used stainless 300 series transfer ball bearings in this system to guarantee it not to rust and degrade causing system failure. These 2 tables are connected with bridge bars to mount to create an 84″×120″ or 70 square feet operation space to handle materials.

FIG. 4: Motor
1. Motor for forward and reverse cutting. This motor is bolted to the table then the table and base units are connected by chains and gears. This moves forward and reverse to allow cutting.
2. Track wire for AC power movement. The lower unit of the machine and rolling table are separate units. So to get power from the base for motor a track is built to house the AC cable allowing it to move forward and backward without kinking or breaking AC cable.
3. Handle has two purposes. First is to be used to manual cut if the motor fails. Secondly, if you desire to cut slower or more quickly.
4. Gear connecting upper table to lower. There are two gears; one on the machine and one on the rolling table. There is a chain connecting the two. This is what is used to link the table and the base.
5. Motor box cover protects the forward and reverse motor from being damaged by water and dust, and material.

FIG. 5: Side View of Drive Motor
1. To disengage motor from machine, this has two purposes. First, if you want different speeds, either slower or faster, you can pull pin and disable motor. Then you can turn the wheel by hand at your desired speed. Secondly, if motor breaks you can pull pin and just use handle manually until motor is repaired.
2. Chain driving machine going around to gear or handle connected to table and bottom gear #4 on FIG. 16 which is connecting to the base at the bottom.
3. Manual wheel
4. Spinning handle or manual wheel
5. Base table is the table that sits directly on base of the roller table. The table has mounting arms that are designed for top table to sit on.
6. Mounting assembly. The bolts and brackets that holds the motor in place and used to set tension on chain that run the machine.

FIG. 6: Slide Extension
1. Slide to support 10″ steel assembly that bolts to machine to hold aprons. This allows saw to move from a limit of 48″ to 54″. Most operators using this type of machine need to cut (2) 26″ pieces before moving slab.
2. Motor area is a reference point to understand where slide assembly is mounted.
3. Spindle shaft is what the left to right movement of blade assembly on a linear guide system.
4. Saw blade is used as a reference point to understand where extension is mounted
5. Apron cover shows covering the spindle that moves left to right keeping dust and water of spindle extending the life of the spindle.
6. 10″ slide extension shows mounted on machine
7. Without extension apron cover, the apron becomes bound making the head stop. With extension, it allows machine to move full range by giving a place for apron to move. This allows machine to go from a limit of 48″ to 54″.
8. Steel extension the extension is a steel assembly built with mounting bolts
9. Apron mounting end shows the shape and cuts to fit apron
10. Apron with notch—the notches show exactly where apron will slide
11. Apron cover for front when extension is mounted

FIG. 7: Utilities Distribution
1. Water—comes in from the floor and splits and goes to two places. First to water solenoid valve so when main motor starts the water is feed to cool blade and second goes to the spigot mounted on utility rack to give operator water any time needed.
2. Electricity-comes from floor and terminates at AC disconnect. From there the power is sent to all motors, lasers and 110AC plugs.
3. Air-compressed comes into machine from the floor and goes to cut off valve and connector.
4. Water spigot is connected to water feed from the floor. Gives operator quick access to water to cool blade, wash off the slab, wash off the table and floor as well as for cooling when using power tools.
5. Solenoid controlled water valve opens when motor is started, AC is sent to solenoid and water valve is opened automatically.
6. Water to cool blade-when motor comes on the solenoid is alerted to turn water on.
7. AC to up/down motor-lets you move head to cutting position and is over the slab allowing you to plunge cut and then raise cutting head to reset table.
8. AC to left/right motor is used to set motor and blade to desired placement to cut size desired.
9. AC disconnect-power is connected to disconnect switch on side that lets you kill all power to machine.
10. Power control box—houses starter, relay switch, PLC and wireless remote interface.
11. AC 110 outlet gives quick access to operator to electricity for using power tools, fan, laser, or lights.
12. Air valve and hook up air hose-lets you attach hose to valve and provide operator with compressed air to use air powered tools or blow dust and/or water off slab and table.
13. AC to main motor comes from #9 feeding power for main motor to run.

FIG. 8: Controllers
1. Manual control panel has 12 separate switches to control all functions: on/off, in/out, up/down, variable speed, rotating switch, preset switches to move motor to move blade to preset area.
2. Touchscreen control panel—has preprogrammed function making it super user friendly. Just touch and watch as everything moves, cuts and resets.
3. Programmable logic controller—is the controller that has all input request and sends to proper output or outputs to accomplish desired tasks. Used by both manual and touchscreen controller.
4. Input controller—the touchscreen version does not have abilities to measure voltage and currents so must use external input to give proper reading.

FIG. 9: Manual Controller
1. Auto reset—is programmed for saw blade to cut material then raise the head, the table moves backward and head raise to 1″.
2. Position 1 when activated blade moves to preset position where most used size is. In the case of our company it is 26″.
3. Position 2 is to set desired size by operator. Our default is 5″ for backsplash.
4. Laser on—when switch is pushed AC is sent to laser and it comes on. Then it will remain on until laser off switch is pushed.
5. Laser off-when switch is pushed it disconnects AC power that feeds laser #4 and laser goes off
6. Water on—when switch is pushed AC is sent to solenoid which activates and water comes on. Then it will remain on until water off switch is pushed.
7. Water off—when switch is pushed, it disconnects AC feeding water #4 and water goes off
8. Plunge cut-when switch activated, raise head to height to clear granite. The granite is rolled forward to where you want the cut to begin. Then motor is turned on and blade is lowered to plunge into granite. Then moves for desired length then motor is cut off, raised and moved to preset location and stop.
9. Auto cut-when switch is activated, starts motor, lower motor to cutting height, table feed to saw blade, when cut is complete, blade raises, table moves in reverse and motor is turned off and motor resets to preprogrammed position.

FIG. 10. Remote Controller
1. Wireless remote—is a walkie/talkie like devise that transmits and receives and lets you control the function, motor on/off, motor forward/reverse, motor up/down, motor left/right and emergency stop.
2. Wired controller—is receiver that convert signals from remote to PLC language and tells what commands to execute.
3. Programmable logic controller—the PLC takes inputs from wireless controller, manual input or touchscreen and converts to correct outputs controlling motors, lasers and water

FIG. 11: Table Overlays
1. Base table—on right is the heavy duty steel table that is 36″ wide. It has support arms on both side.
2. Top table-On left is the fully complete top overlay table. They are one same page to show how they must line up perfectly for maximum support meaning less flex on complete table.
3. Boards with exposed bearings—showing how the bearings are up just enough to clear the wood but materials slides across effortlessly
4. Side view of base table-shows the arms 20″ on right and 26″ on left. Base table is drilled and tapped then arms are attached to the table with large bolts.
5. Counter weights for tables. By design you are limited how far you can move slab to right of table which is 26″ but you need to put 120″ piece on the table. So if the table is 36″ and your rights sided is 26″ leaving 58″ overhang to left. So on right you have 26″ but on right you have 58″. Most of the time this is not a problem but when you move a 400-500 lb piece of material to that side of the table it will tilt over. So to correct this problem finding center of table and added weight which was level when 400 lbs are on the left. We then welded weight 100-300 lbs on right to achieve this. Once we found correct weight, we welded to underside of the table.

FIG. 12: Base Table
1. 26″ support-on left side as shown in FIG. 11.
2. 20″ support-on right side as shown in FIG. 11.
3. The base table has been drilled and tapped on side of table so heavy duty bolts can support bracing. So it can bolt right on to base table and will act as one single unit.
4. Drilled and tapped to bolt top overlay table

FIG. 13: Phase 1 Top Table 2 Sides
1. Left side welded together—There are 2 sides to our of the top table overlay due to its size. When completed, it is 120″×120″ which is not easy or cost effective to ship so it is built in 2 sides that bolt together becomes one unit for table top overlay.
2. Right side welded together
3. Angle braces welded for support

FIG. 14: Phase 2 Top Table with Bearings
1. Left side stop and squaring module attached—to move pin anywhere needing for material to be square or where material could be accidently pushed off roller table.
2. Right side stop and squaring module attached- to move pin anywhere needing for material to be square or where material could be accidently pushed off roller table.
3. Top View Adjustable plates to attach and square tables—is the combination of bolts holes drilled into separate the piece mounted outside tubing. It also has top holes in outer piece.
4. Ball transfer bearing—is #5 are added, these are all stainless 300 series bearings which allows for no rust in wet environment. They are spaced to give maximum supports in smallest area possible.
5. Side view of ball transfer bearing-shows stud that goes through metal, then housing to side flat for stability. Lastly the ball that all material rolls on.
6. Top view of adjustable plate-showing series of bolts bolted to the piece of steel table and other bolts through first metal to become locking bolts.
7. Close up view of adjustment system with bolts.—There are 6 bolts, 4 are tightened plates on the table. The other two are bolted to outside of plate that pushes against inside steel piece.
8. Side view showing 6 holes. The four outside are drilled through and the two center ones are drilled and tapped.
9. Plate on top table—is the plate mounted to top table. You see there are four holes to bolt it and the other two back two bolts.

FIG. 15: Phase 3 Bolt Boards
1. Board overlay-once base table is built and top overlay table is mounted to the base. Then in phase 3 we bolt boards with predrilled holes the line up with mounted bearings. The holes are larger to allow the material like dust and debri will wash off and drain down outside part of holes keeping it away from bearings.
   This design will reduce the amount of trash on bearing by 50% extending bearing life.

FIG. 16: Phase 4 Completed Top Table
1. Measuring bars gauged in 1″ increments
2. Stop pin holder
3. Counter weights
4. Aligning squaring and stops

FIG. 17: Measuring Bars
1. Layout and Measuring Bars
2. Size Pin # and Size Reference
3. Standard base pin 1¼″

FIG. 18: Measuring Pin
1. Sizing pins for chart on FIG. 17

FIG. 19: Measuring System 4 Different Ways to Get Precise Measurements
1. Measuring bar for 0-26″ or 0-96″ going in opposite directions.
2. Top view of #1 mounted across machine
3. Shows 3″ gauging pin from FIG. 18 mounted in gauging bar.
4. Shows 1½ ″gauging pin from FIG. 18 mounted in gauging bar.
5. The second measuring bar has measurements 0-120″
6. Laser to line up measurements for precise cuts
7. Pointer giving an accurate measurement.
8. Machine measure stick 0-60″ mounted to steel bar and bolted to moving part of machine.
9. Close up of #8 showing 0-60″ measurement.
10. Laser line on slab is green or red line for aligning cuts.
11. Stop pins in place—These side pins are the key to precise straight edge cuts.

FIG. 20: Ball Transfer Bearings
1. 1″ ball bearing which material rolls on
2. 80⅛″ support bearings that 1″ bearing rolls on
3. Mounting stud to mount to table and bridge bars
4. Membrane to block trash from getting to bearings
5. Outer cover

FIG. 21: Machine Slab to Cut
1. Full slab on table ready to cut 1^{st} side

FIG. 22: Machine with Slab Cut on Table
1. Measuring and gauging bars
2. Stops in place to hold slab for cut
3. Slab
4. Slab with 1 side cut straight

FIG. 23: Machine with Holding Tables
1. Roller tables
2. Pin stop holders
3. Bridge bar supports
4. Slab with all four sides cut and now squared

FIG. 24: Table Cutting Slab
1. Saw head moved to 26″ to make 1^{st} cut to length
2. 26″ piece cut and moved to holding table
3. Arrow showing motion of #2

FIG. 25: Machine Cutting Head at 26″
1. Cutting head stays at 26″ mark on ruler
2. Move to holding table in FIG. 24 #2 and set stop pins at 24′ Making cut and move over and up on holding table.
3. Move from slab to set pins at 12″. Make cut and move over and up on holding table
4. Move from slab to set pins at 5″. Make cut and move over and up on holding table.
5. So motor head with blade is at fixed position during all cuts 26″, 24″, 12″, and 5″.

FIG. 26: Rotate Pieces to Cut
1. 26″ pieced is moved in position to crosscut to correct length
2. Piece set to cut to length
3. Put stop pins at desired length to act as stops
4. Move motor if needed to make desired cuts

FIG. 27: Cut Pieces Ready to Profile and Polish
1. Piece 1 Set in desired place to profile, polish and seal.
2. Piece 2 Set in desired place to profile, polish and seal.
3. Piece 3 Set in desired place to profile, polish and seal.
4. Piece 4 Set in desired place to profile, polish and seal.

1. A saw and movement system allowing a single operator to cut and move slab material anywhere on the machine and extension tables anywhere up to 360°, consisting of saw with roller top, extension roller tables, Bridgeway bars and soft spot landing areas.

2. A saw and movement system in claim #1 further comprised of tops and tables having stainless steel ball transfer bearings that are mounted with proper spacing and distance to fully support material.

3. A saw and movement system in claim #1 further comprised of tops and tables having soft spots landing areas.

4. A saw and movement system in claim #1 further comprised with tables having mounts for Bridgeway bars which are steel bars with ball transfers being mounted on top to comprise a bridge. These Bridgeway bars bridge the two tables together making it one work area and at the end of the table studs are mounted to have a spot to store the Bridgeway bars when not in use.

5. A saw with measurement system which allows for true and accurate cutting system consisting of gauge bars, gauging pins, stop pins, laser, and rulers.

6. A saw with measurement system in claim #5 further comprised of gauge bars which have holes drilled in every inch but staggered creating two rows that create one row that is even numbered and one row that is odd numbered which the holes are 2″ apart.

7. A saw with measurement system in claim #5 and #6 composed of even and odd numbered rows further separated by color coding the even one color and the odd another color.

8. A saw with measurement system in claim #5, further comprised of pins ranging from 1″ to 3″ in ¼″ increments that go in the holes on gauging bar giving operator quick and easy set up measurements that accurate within ⅛″.

9. A saw measurement system in claim #5 and #8 further comprised of two colors. The first pin sizes are 1″, 1½″, 2″ 2½′, and 3″ are one color and are used for setting measurements in ¼″ increments. The second color pin are 1¼″, 1¾″, 2¼″, 2¾″ that will give you measurements in ⅛″ increments.

10. A saw with utility distribution system comprised of electricity, water, and compressed air.

11. A saw with utility distribution system in claim #10 is first connections of the distribution to the main machine.

12. A saw with utility distribution system in claim #10 installing the three utilities to a distribution bar mounted on the side of the machine with plugs outlets for AC, spigot and fitting for the compressed air.

13. A saw with utility distribution system in claim #10 consisting of cantilever with rings and pole allowing the three utilities to run through pipe and up above main machine and out far enough to clear outer parameters of cutting table. The pole is connected using collar bearing mounts which the pole slides through and locks in place. This allows the pole to rotate 360°. There are hooks connected to cantilever that allow the utilities to run down and end of hook is to store accessories to use with these utilities.
